(19) United States
(12) Patent Application Publication
(10) Pub. No.: US 2015/0019612 A1
(43) Pub. Date: Jan. 15, 2015

(54) PROVIDING DEVICE-SPECIFIC INSTRUCTIONS IN RESPONSE TO A PERCEPTION OF A MEDIA CONTENT SEGMENT

(71) Applicant: Google Inc., Mountain View, CA (US)

(72) Inventors: Matthew Sharifi, Zurich (CH); Gheorghe Postelnicu, Zurich (CH)

(21) Appl. No.: 13/938,216

(22) Filed: Jul. 9, 2013

(51) Int. Cl. H04L 29/08

(52) U.S. Cl. CPC H04L 67/10
USPC 709/201

(57) ABSTRACT

Systems and methods are disclosed for providing device-specific instructions in response to a perception of a media content segment. In one implementation, a processing device captures, at a user device, one or more media content segments. The processing device provides the one or more media content segments to a remote device. The processing device receives one or more instructions, each of the one or more instructions being associated with at least one of the one or more media content segments and corresponding to one or more operations. The processing device initiates execution of at least one of the one or more instructions.

### TECHNICAL FIELD

Aspects and implementations of the present disclosure relate to data processing, and more specifically, providing device-specific instructions in response to a perception of a media content segment.

### BACKGROUND

Audio and video content can be stored on data servers and provided to users for listening/viewing over the Internet. Applications for supporting the listening/viewing of such audio and video content may be browser-based, or may run independently of a browser.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device receives one or more media content segments from a user device. The processing device processes the one or more media content segments to determine one or more operations associated with the one or more media content segments. The processing device selects, based on one or more characteristics associated with the user device, at least one of the one or more operations. The processing device provides one or more instructions to perform the at least one of the one or more operations in relation to the user device.

In another aspect of the present disclosure, a processing device captures, at a user device, one or more media content segments. The processing device provides the one or more media content segments to a remote device. The processing device receives one or more instructions, each of the one or more instructions being associated with at least one of the one or more media content segments and corresponding to one or more operations. The processing device initiates execution of at least one of the one or more instructions.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts a flow diagram of aspects of a method for providing device-specific instructions in response to a perception of a media content segment.

FIG. 3 depicts an exemplary scenario where two user devices perceive the same media content segment, in accordance with one implementation of the present disclosure.

FIG. 4 depicts an exemplary notification that can be provided to a content provider, in accordance with one implementation of the present disclosure.

FIG. 5 depicts an exemplary scenario where two user devices perceive the same media content segment, in accordance with one implementation of the present disclosure.

FIG. 6 depicts a flow diagram of aspects of a method for providing device-specific instructions in response to a perception of a media content segment.

FIG. 7 depicts exemplary implementations of a media content capture trigger, in accordance with one implementation of the present disclosure.

FIG. 8 depicts an exemplary scenario whereby different sets of instructions can be presented at respective user devices, in accordance with one implementation of the present disclosure.

FIG. 9 depicts an exemplary scenario whereby instructions can be presented in response to selection of various media content capture triggers, in accordance with one implementation of the present disclosure.

FIG. 10 depicts a block diagram of an illustrative computer system operating in accordance with aspects and implementations of the present disclosure.

### DETAILED DESCRIPTION

Aspects and implementations of the present disclosure are directed to providing device-specific instructions in response to a perception of a media content segment. The systems and methods disclosed can be applied to media content such as audio and/or video content, such as content projected, displayed, or otherwise provided at a media player (e.g., a television, radio, computer, etc.). More particularly, while a considerable amount of the media content to which a user is exposed (e.g., television programming, radio programming, media retrieved from the Internet, etc.) may encourage or suggest that the user perform one or more follow-up actions or operations (e.g., to make a phone call, visit a website, etc.), the user is primarily responsible for ensuring that such a follow-up occurs, as well as for ensuring that the necessary parameters (e.g., the phone number, website address, etc., required for the follow-up operation) are accurate. As such, many situations arise where a user, though intending to initiate a follow-up operation, is unsuccessful in doing so (e.g., when a user is preoccupied and later forgets to do so, when a user does not remember the follow up parameters properly, etc.). Moreover, even when a user is otherwise capable of initiating a follow-up operation (as instructed in the media content such as the advertisement), such an operation may be sub-optimal for the particular user. For example, a radio advertisement instructing listeners to call a specific phone number may be ineffective with respect to a user who is incapable of making a phone call (or does not wish to), while an instruction to visit a website may be similarly ineffective with respect to other users.

Accordingly, described herein in various embodiments are technologies that enable content providers (such as advertisers) to associate multiple operations to a single media content segment (such as an audio clip of an advertisement). Upon hearing an advertisement, for example, a user can initiate or trigger a mobile application at a user device which can capture and transmit a clip of the advertisement to a server. The server can process the received clip in relation to a data store of content provided by such advertisers. Upon identifying a match from the data store, an associated operation (as defined by the advertiser) can be selected and transmitted back as an instruction to the user device to perform the particular operation (navigate to a website, call a phone number, etc.). Given that, as noted, a single content item in the data store can be associated with multiple operations, the particular operation to be selected for transmission back to the user device can be determined based on various characteristics of the user device. For example, a content provider can associate different operations to user devices having different characteristics (e.g., being present in different geographic locations, being associated with different interests or demographics, etc.). In doing so, the referenced follow-up operations can be more easily and accurately achieved by users, and different operations can be provided to different types of users, even with respect to a single content item (e.g., an advertisement). For example, when a user hears a relevant advertisement, the user may be able to press a button provided by a mobile application on a user mobile device. In response, the mobile application may obtain a phone number associated with the advertisement or a URL of a website associated with the advertisement from a server, and may present the obtained phone number or website URL to the user, or cause the phone number to be automatically dialed or the website to be automatically displayed on the user mobile device.

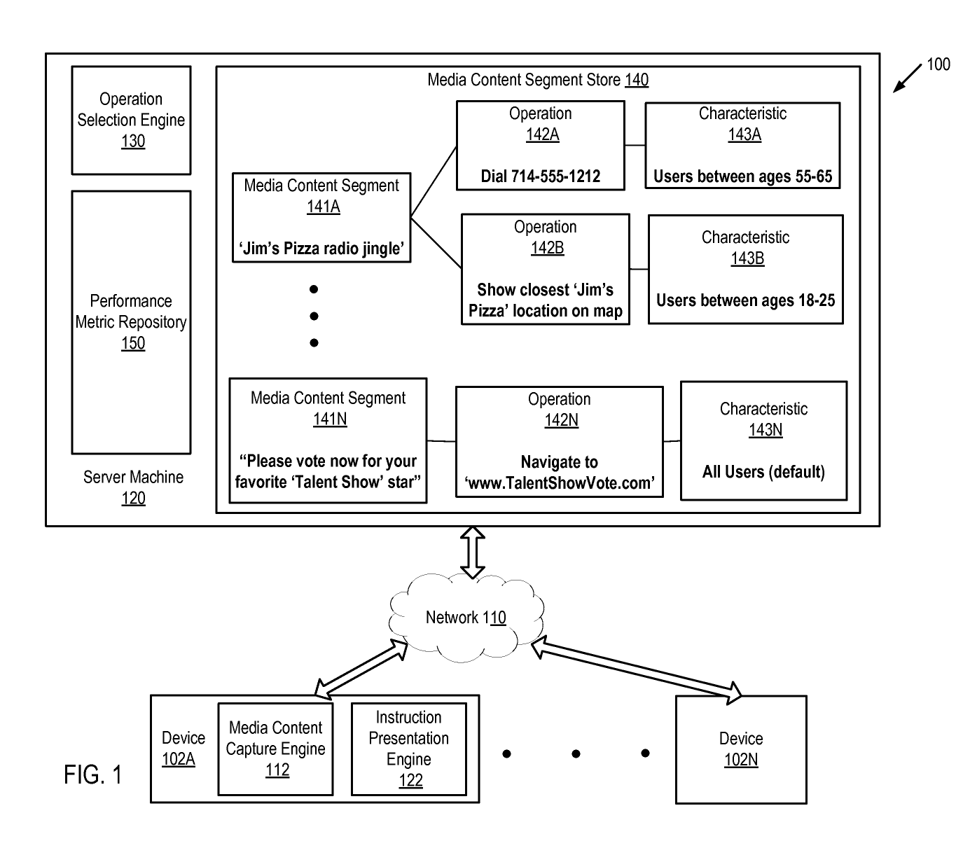

FIG. 1 depicts an illustrative system architecture 100, in accordance with one implementation of the present disclosure. The system architecture 100 includes user devices 102A-102N and server machine 120. These various elements or components can be connected to one another via network 110, which can be a public network (e.g., the Internet), a private network (e.g., a local area network (LAN) or wide area network (WAN)), or a combination thereof.

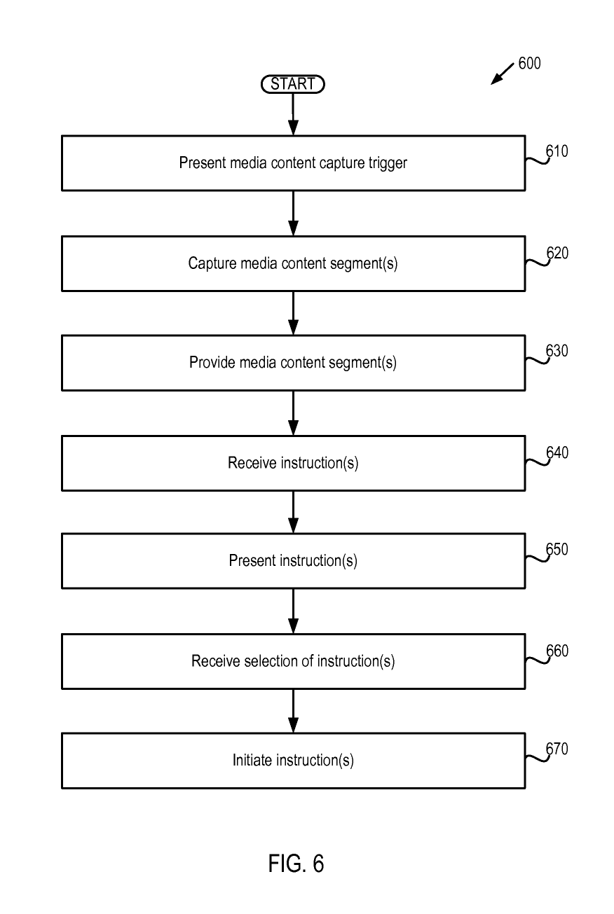

User devices 102A-102N can be wireless terminals (e.g., smartphones, etc.), personal computers (PC), laptops, tablet computers, or any other computing or communication devices, and can be geographically distributed anywhere throughout the world. The user devices 102A-102N may run an operating system (OS) that manages hardware and software of the user devices 102A-102N. Each user device 102 can include one or more components and such components can be combined together or separated into further components, according to a particular implementation. It should be noted that in some implementations, various components of a user device 102 may run on separate machines. Moreover, some operations of certain of the components are described in more detail below with respect to FIG. 6.

For example, a user device 102 can include a media content capture engine 112. Media content capture engine 112 can be, for example, an application, module, and/or set of instructions that can be initiated or triggered (such as by a user) to capture a media content segment (e.g., an audio clip, a video clip, etc.) of media content that is perceptible to the device (e.g., audio originating at a radio that can be heard or otherwise perceived by an integrated microphone of the device, video content originating at a television, computer, etc., that can be viewed or otherwise perceived by an integrated camera of the device, etc.) and can further provide (e.g., upload) the media content segment to server machine 120 (e.g., via network 110). Moreover, in certain implementations media content capture engine 112 can configure a user device 102 to provide a media content capture trigger (e.g., an icon, button, text hyperlink, and/or any other such indicator) that can be incorporated within and/or otherwise presented in conjunction with the interface of one or more other applications that are executing on a user device. Such a media content capture trigger can enable a user to select or otherwise initiate such a trigger (e.g., by pressing on the icon via a touchscreen interface) while also utilizing/interacting with another application (e.g., a text messaging application, web browser, etc.).

A user device 102 can also include an instruction presentation engine 122. Instruction presentation engine 112 can be, for example, an application, module, and/or set of instructions that can receive one or more instructions (e.g., to initiate a phone call, navigate to a location, etc.), such as those instructions that can be provided in response to the capture and providing of a media content segment, and can present such instructions to a user, such as at an interface of the user device 102, as described herein.

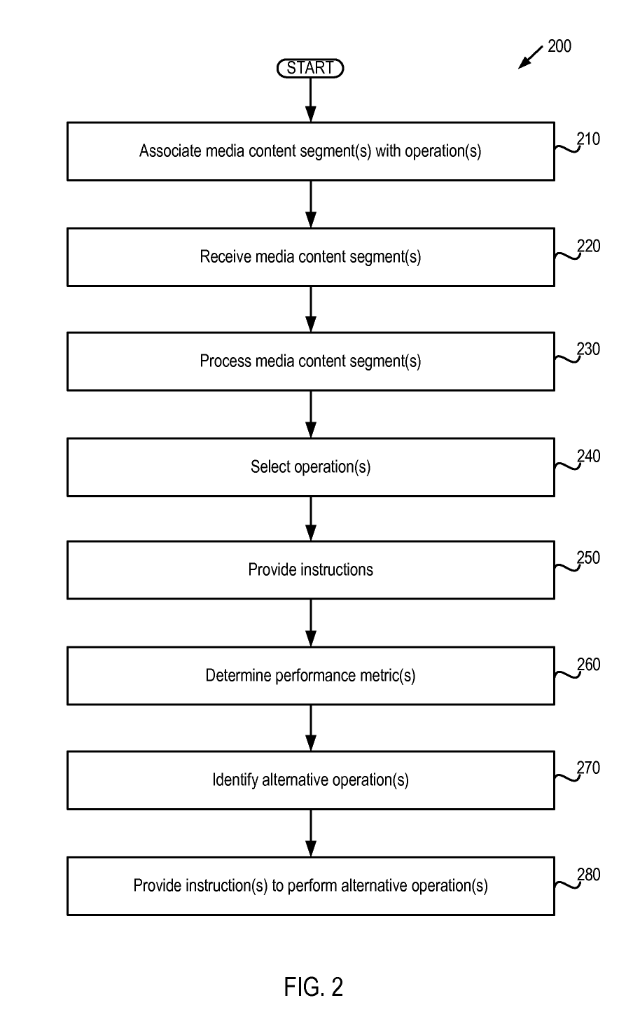

Server machine 120 can be a rackmount server, a router computer, a personal computer, a portable digital assistant, a mobile phone, a laptop computer, a tablet computer, a camera, a video camera, a netbook, a desktop computer, a media center, any combination of the above, or any other such computing device capable of implementing the various features described herein. Server machine 120 can include components such as operation selection engine 130, media content segment store 140, and performance metric repository 150. The components can be combined together or separated in further components, according to a particular implementation. It should be noted that in some implementations, various components of server machine 120 may run on separate machines. Moreover, some operations of certain of the components are described in more detail below with respect to FIG. 2.

Media content segment store 140 can be hosted by one or more storage devices, such as main memory, magnetic or optical storage based disks, tapes or hard drives, NAS, SAN, and so forth. In some implementations, media content segment store 140 can be a network-attached file server, while in other implementations media content segment store 140 can be some other type of persistent storage such as an object-oriented database, a relational database, and so forth, that may be hosted by the server machine 120 or one or more different machines coupled to the server machine 120 via the network 110, while in yet other implementations media content segment store 140 may be a database that is hosted by another entity and made accessible to server machine 120.

Media content segment store 140 can include media content segments 141A-141N. In certain implementations, media content segments 141A-141N can correspond to media content itself (e.g., audio clips of audio advertisements, video clips of video advertisements, images of print advertisements, etc.) and/or fingerprints of such media content (e.g., quantitative data derived from features such as color, intensity, frequency, etc.), as well as data structures to associate the media content segments with their respective fingerprints (e.g., a table in which each row stores an identifier of an audio, video, or image segment and fingerprint data for that audio, video, or image segment, etc.). Upon receiving a media content segment, as can be captured, for example, at a user device 102 and transmitted to server machine 120, the received media content segment can be compared to and/or otherwise analyzed in light of the media content segments in the media content segment store 140. In doing so one or more matches and/or similarities between the captured/received media content segment and those media content segments stored in media content segment store 140 can be identified.

Each media content segment 141 can be associated with one or more operations such as operations 142A-142N. Operations 142A-142N can be one or more instructions or commands that can be provided to and/or in relation to user devices 102A-102N (e.g., instructions to dial a particular phone number, navigate to a particular website, show a particular location on a map, etc.), such as based on a similarity, a match, or any other such determination with respect to a media content segment, such as a media content segment captured at a user device 102. Such operations can be executed at user devices 102A-102N in order to change or affect the operation of the user devices 102A-102N in one or more ways. It should be noted that, as depicted in FIG. 1, a single media content segment (such as media content segment 141A) can be associated with multiple operations (such as operation 142A and operation 142B).

In certain implementations, one or more of the referenced operations 142A-142N can be associated with various characteristics 143A-143N, such as characteristics of the location of a user device (or devices) and/or characteristics of a user associated with the user device. Such characteristics can be considered with respect to determining which of several associated operations is/are to be selected with respect to a particular media content segment, as described in detail herein. In certain implementations, such operations can be selected by operation selection engine 130 of server machine 120, which can be configured to select various operations based on receipt of a particular media content segment or segments and to provide corresponding instructions that can be executed, for example, in relation to a user device 102.

Performance metric repository 150 can include one or more performance metrics (e.g., conversion rate) (not shown), such as performance metrics that can be calculated or determined in relation to various operations, such as operations 142A-142N. Such performance metrics can be considered with respect to determining alternative operations to provide with respect to particular media content segment, as described in detail herein.

FIG. 2 depicts a flow diagram of aspects of a method 200 for providing device-specific instructions in response to a perception of a media content segment. The method is performed by processing logic that may comprise hardware (circuitry, dedicated logic, etc.), software (such as is run on a general purpose computer system or a dedicated machine), or a combination of both. In one implementation, the method is performed by server machine 120 of FIG. 1, while in some other implementations, one or more blocks of FIG. 2 may be performed by another machine. For example, in various alternative implementations, the method can be performed at a user device 102 (i.e., the method or various aspects thereof can be performed locally at the device 102 rather than in communication with a server such as server machine 120).

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 210, one or more media content segments can be associated with one or more operations. That is, a content provider such as an advertiser can provide (e.g., upload) content (e.g., media content such as audio clips, video clips, etc.) to media content segment store 140 of server machine 120. For example and with reference to FIG. 1, various content providers can provide audio clips such as a product theme song (e.g., media content segment 141A ‘Jim's Pizza radio jingle’) or an audio prompt (e.g., media content segment 141N “Please vote now for your favorite ‘Talent Show’ star”). Having provided such media content segments, the content provider can further associate each segment with one or more operations. For example, as shown in FIG. 1, media content segment 141A can be associated with operations including operation 142A (‘Dial 714-555-1212’) and operation 142B (‘Show closest ‘Jim's Pizza’ location on map’), while media content segment 141N can be associated with operations including operation 142N (‘Navigate to ‘www.TalentShowVote.com’). It should be understood that the referenced operations are exemplary and that any number of other operations (e.g., adding a contact to an address book, navigating to a particular location, playing media content such as a video, etc.) can be similarly implemented. In one aspect, block 210 is performed by operation selection engine 130.

At block 220, one or more media content segments are received. Such media content segments can be received from a device such as one of user devices 102A-102N (e.g., a smartphone, etc.). Moreover, such media content segments can be captured at such devices 102A-102N such as via an integrated audio and/or video capture device (e.g., a microphone or camera). In certain implementations, the referenced media content segments can be captured in response to a user selection. For example, upon hearing, seeing, or otherwise perceiving media content (e.g., hearing ‘Jim's Pizza radio jingle’ playing on the radio, hearing/seeing a prompt on television to “Please vote now for your favorite ‘Talent Show’ star,” etc.), a user can initiate or trigger a mobile application (‘app’) on the user device 102, such as in the manner described with respect to FIG. 6. The mobile application can be configured to capture a media content segment (e.g., an audio clip of the perceived media content originating at the radio, television, etc.) and can further provide (e.g., upload) the media content segment to server machine 120 (e.g., via network 110).

Moreover, in certain implementations the referenced media content segments can be provided in response to a user selection. That is, in certain implementations the referenced mobile application executing at user device 102 can be configured to continuously and/or periodically capture media content (i.e., even without user initiation or prompting), and a user can subsequently elect to initiate or trigger the application to provide such captured media content segments (e.g., even when the audio/video prompt desired by the user is no longer being played/displayed). In one aspect, block 220 is performed by media content segment store 140.

At block 230, the media content segments (such as those received at block 220) are processed. In doing so, one or more operations associated with the media content segments can be determined. For example, a received media content segment (e.g., an audio clip captured by user device 102A) can be compared to and/or otherwise analyzed in light of the media content segments 141A-141N in media content segment store 140. In doing so one or more matches and/or similarities between the captured/received media content segment and those media content segments stored in media content segment store 140 can be identified (e.g., by comparing the respective content fingerprints of the received media content and the media content segments in the media content segment store). In one aspect, block 230 is performed by operation selection engine 130.

Having identified a particular media content segment received from a user device 102 as being comparable or otherwise similar to a media content segment 141 stored in media content segment store 140, various operations (e.g., those associated with the referenced media content segment 141 at block 210) can be determined. For example, with respect to media content received from user device 102A that has been determined to be comparable to media content segment 141A (‘Jim's Pizza radio jingle’), the various operations associated with the media content segment (e.g., operation 142A and operation 142B) can be determined.

At block 240, one or more of the operations (such as those determined at block 230) is selected. That is, being that a media content item can be associated with multiple operations (such as media content item 141A as shown in FIG. 1), a selection can be made with respect to the particular operation (or operations) to be provided to or otherwise employed with respect to the media content item. In certain implementations, such operations can be selected based on one or more characteristics associated with the device. That is, it can be appreciated that it can be advantageous for a content provider such as an advertiser to select one operation with respect to a device associated with one characteristic (e.g., a user characteristic) while selecting (with respect to the same media content segment) another operation with respect to a device associated with a different characteristic. It should be understood that such characteristics can be identified or determined, for example, based on metadata provided by a user device 102 in conjunction with the media content provided by the user device 102 to server machine 120. In one aspect, block 240 is performed by operation selection engine 130.

For example, in certain implementations, the referenced characteristics can include one or more location characteristics associated with the first device. In such a scenario, a content provider such as an advertiser can define or designate that, with respect to a particular media content segment (e.g., media content segment 141A) one operation (e.g., operation 142A) is to be selected with respect to devices that can be determined to be associated with one geographic area (e.g., a particular city, zip code, state, country, etc.), while another operation (e.g., operation 142B) is to be selected with respect to devices that can be determined to be associated with another geographic area. In doing so, a single media content segment can be used to trigger different operations with respect to devices determined to be in different locations.

Moreover, in certain implementations, the referenced characteristics can include one or more user characteristics associated with the first device (e.g., user characteristics associated with a user account or profile that is logged into the device). In such a scenario, a content provider such as an advertiser can define or designate that, with respect to a particular media content segment (e.g., media content segment 141A) one operation (e.g., operation 142A) is to be selected with respect to devices that can be determined to be associated with a particular user characteristic (e.g., a particular interest, demographic, etc.), while another operation (e.g., operation 142B) is to be selected with respect to devices that can be determined to be associated with another user characteristic. By way of illustration, a content provider such as an advertiser can define that, with respect to devices that can be determined to be associated with a particular characteristic (e.g., users between the ages of 55-65), one operation (e.g., dial a phone number, add a phone contact to a user address book, etc.) can be selected with respect to a particular identified media content segment (e.g., audio from a radio or television advertisement), while also defining that, with respect to devices that can be determined to be associated with another characteristic (e.g., users between the ages of 18-25), another operation (e.g., navigate to a website, navigate to a social networking page, etc.) can be selected with respect to the same media content segment. In doing so, a single media content segment (originating, for example, from a television or radio commercial) can be used to trigger different operations with respect to devices determined to be associated with different user characteristics.

By way of yet further illustration, a content provider such as an advertiser can define that, with respect to devices that can be determined to be associated with a particular characteristic (e.g., an operational capability such as the ability to make phone calls), one operation (e.g., dial a phone number) can be selected with respect to a particular identified media content segment (e.g., audio from a radio or television advertisement), while also defining that, with respect to devices that can be determined to be associated with other characteristic(s) (e.g., the ability to view website and/or no ability to make calls, etc.), another operation (e.g., navigate to a website) can be selected with respect to the same media content segment. By way of yet further illustration, a content provider such as an advertiser can define that, with respect to devices that can be determined to be associated with a particular characteristic (e.g., being signed in to or otherwise associated with one social network), one operation (e.g., opening content or otherwise navigating to a page associated with the same social network that the device is associated with) can be selected with respect to a particular identified media content segment (e.g., audio from a radio or television advertisement), while also defining that, with respect to devices that can be determined to be associated with other characteristic(s) (e.g., being signed in to or otherwise associated with another social network), another operation (e.g., opening content or otherwise navigating to a page associated with that social network) can be selected with respect to the same media content segment. In doing so, a single media content segment (originating, for example, from a television or radio commercial) can be used to trigger different operations with respect to devices determined to be associated with different user characteristics.

It should be noted that in situations in which the systems discussed herein collect personal information about users, or may make use of personal information, the users may be provided with an opportunity to control whether programs or features collect user information (e.g., information about a user's media viewing history, interests, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

It should also be noted that various operations (such as operation 142N as shown in FIG. 1) can be associated with a single or default characteristic (or, alternatively, associated with no characteristics). In such scenarios, the same operation can be employed with respect to all users with respect to which the associated media content segment (e.g., media content segment 141N) is received.

At block 250, one or more instructions are provided. In certain implementations, such instructions can be to perform one or more operations (such as those selected at block 240) in relation to a device such as a user devices 102. For example, an instruction or command can be transmitted or otherwise provided from server machine 120 to a user device 102 via network 110. Upon receiving such instructions, the receiving user device can execute or otherwise implement the received instructions (e.g., to dial a phone number, navigate to a web page, etc.). In one aspect, block 250 is performed by operation selection engine 130.

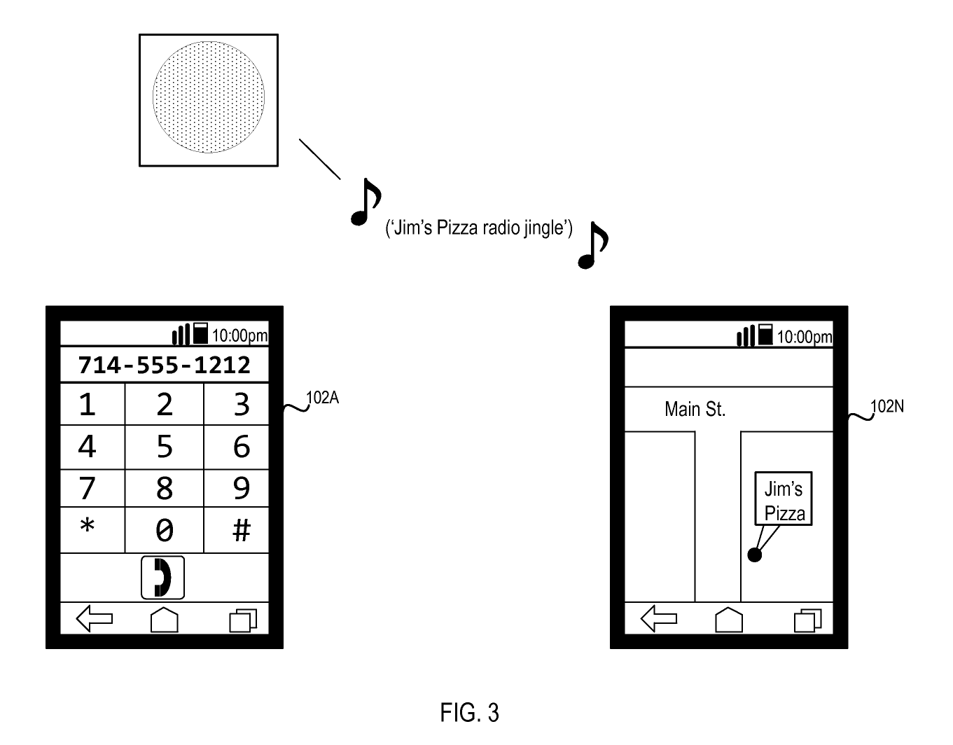

For example, FIG. 3 depicts an exemplary scenario whereby user devices 102A and 102N both perceive ‘Jim's Pizza radio jingle’ playing on the radio, and the respective users of each device trigger or activate an application that captures and transmits a media content segment to server machine 120. As depicted in FIG. 3, while both devices have perceived the same instance of ‘Jim's Pizza radio jingle,’ the instruction provided to device 102A can be to dial a particular phone number, while the instruction provided to device 102N can be to show the closest ‘Jim's Pizza’ location on the map. As described herein, the respective instructions can be provided based on characteristics that can be determined with respect to each device (as provided, for example, as metadata in conjunction with the media content segment transmitted from the user device to server machine 120). In doing so, a content provider (e.g., an advertiser) can designate different operations/instructions to be provided to different types of users with respect to the same perceived content (e.g., the same radio advertisement).

Moreover, in certain implementations, instructions to provide an option to perform the one or more operations in relation to the device can be provided. That is, in lieu of executing the received instructions upon their receipt at user device 102, an option can be presented or otherwise provided at the device enabling a user to select whether and/or how a particular received instruction is to be implemented at the device. For example, a prompt can be presented to the user, requesting approval or disapproval of the received instruction(s) (e.g., ‘Do you want to call Jim's Pizza now?,’ Do you want to vote in the Talent Show?,′ etc.).

At block 260, one or more performance metrics can be determined. In certain implementations, such performance metrics can be determined in relation to various operations, such as the operations selected at block 240. That is, it can be appreciated that certain operations can be more effective than others with respect to facilitating a conversion (e.g., a purchase, a sign-up, etc.) on the part of the user. As such, it can be advantageous to maintain various performance metrics that can reflect the varying degrees that certain operations succeed in achieving a particular outcome such as a conversion (e.g., a conversion rate). In one aspect, block 260 is performed by performance metric repository 150.

At block 270, one or more alternative operations can be identified. In certain implementations, such alternative operations can be identified based on the one or more performance metrics, such as those determined at block 260. For example, in certain implementations, the referenced alternative operations can be identified based on having respective performance metrics that are greater than the one or more performance metrics of the operations selected at block 240. That is, it can be further appreciated that while a content provider such as an advertiser may initially associate a particular operation to a particular media content segment, such an operation may not subsequently achieve a desired outcome, (such as a particular conversion rate), or may otherwise be sub-optimal. In such scenarios (e.g., in scenarios where a conversion rate for a particular operation can be determined to be less than the conversion rates for other operations associated with the same media content segment), various alternative operations can be identified (e.g., other operations that can be determined to have higher performance metrics), and a notification/prompt can be generated and provided to the content provider (e.g., an advertiser) suggesting that the alternative operation(s) be implemented. Alternatively, operation selection engine 130 can be configured to select alternative operation(s) for the media content segment in an automated fashion, without requiring additional input from the content provider. In one aspect, block 270 is performed by operation selection engine 130.

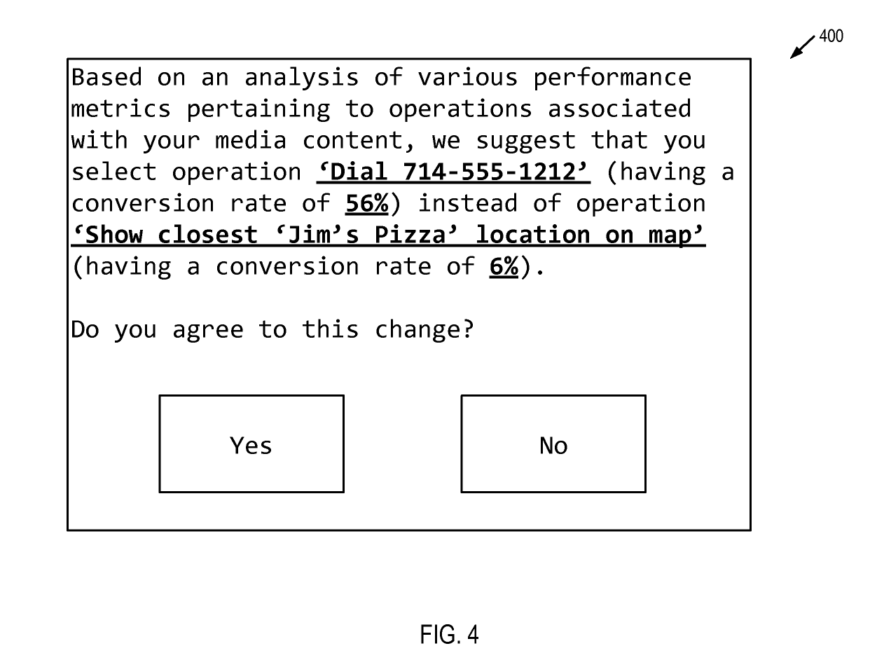

By way of illustration, FIG. 4 depicts an exemplary notification 400 that can be provided to a content provider such as an advertiser. Such a notification can reflect a suggestion that the content provider select an alternative operation (operation 142A ‘Dial 714-555-1212’) in lieu of another operation (operation 142B ‘Show closest ‘Jim's Pizza’ location on map′), in light of a determination that the alternative operation generates more conversions (e.g., purchases).

At block 280, one or more instructions to perform the alternative operations (such as those identified at block 270) in lieu of the one or more operations can be provided. For example and with reference to FIG. 4, upon receipt of an affirmative selection (such as by a content provider) in response to the notification, an instruction can be provided to perform the alternative operation in lieu of the operation originally designated by the content provider. In one aspect, block 280 is performed by operation selection engine 130.

At this juncture, it should be noted that while much of the present disclosure is described with respect to a content provider designating various operations/instructions to be provided or otherwise effected upon the identification of media content items (such as advertising content) originating from the content provider itself (e.g., an advertisement provided or sponsored by the advertiser), in other implementations such operations/instructions can be associated with (and subsequently provided in relation to) media content items that originate from other sources.

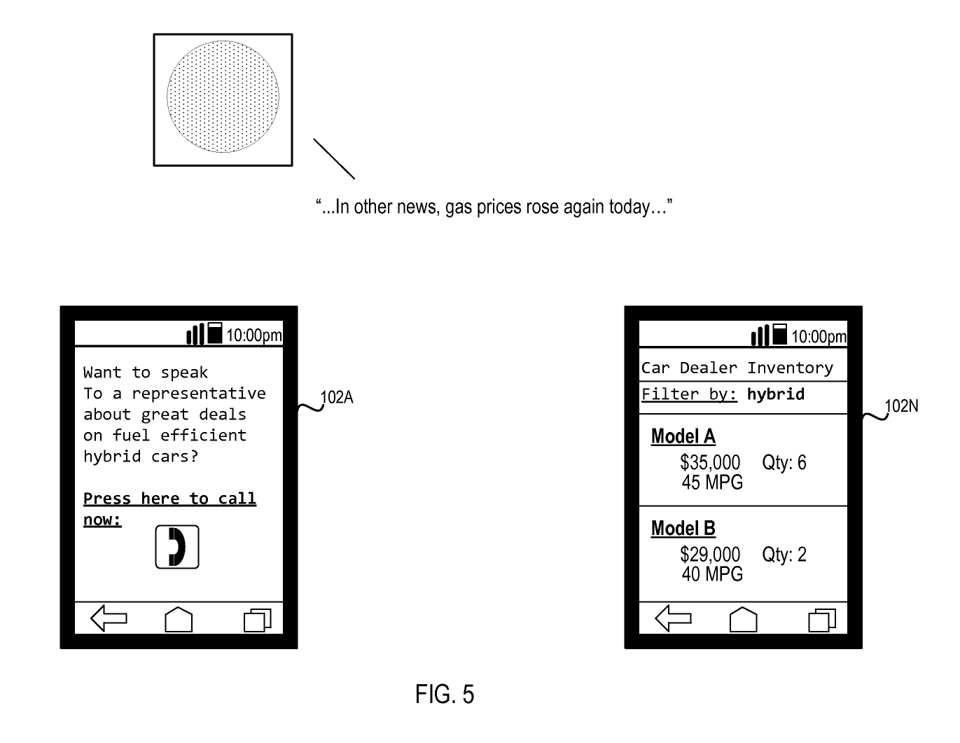

For example, FIG. 5 depicts an exemplary scenario whereby user devices 102A and 102N both perceive a news report stating that “ . . . In other news, gas prices rose again today . . . ” While such content (i.e., the news report) originates at a third party (e.g., a news radio station), the various technologies described herein can be configured to associate operations to media content items that are comparable to such third-party content. For example, an advertiser can associate various operations with the media content segment “gas prices,” and can further associate different operations to be provided to devices having different characteristics, as described herein (e.g., providing an option to speak to a sales representative to device 102A based on various characteristics associated with the device, while also providing, in response to the same media content segment, a car dealership inventory to device 102N based on characteristics associated with that device). In doing so, a content provider (e.g., an advertiser) can designate different operations/instructions to be provided to different types of users with respect to the same perceived content, even when such content originates from a third-party source (such as a news source, etc.).

FIG. 6 depicts a flow diagram of aspects of a method 600 for providing device-specific instructions in response to a perception of a media content segment. The method is performed by processing logic that may comprise hardware (circuitry, dedicated logic, etc.), software (such as is run on a general purpose computer system or a dedicated machine), or a combination of both. In one implementation, the method is performed by a user device 102 of FIG. 1, while in some other implementations, one or more blocks of FIG. 6 may be performed by another machine.

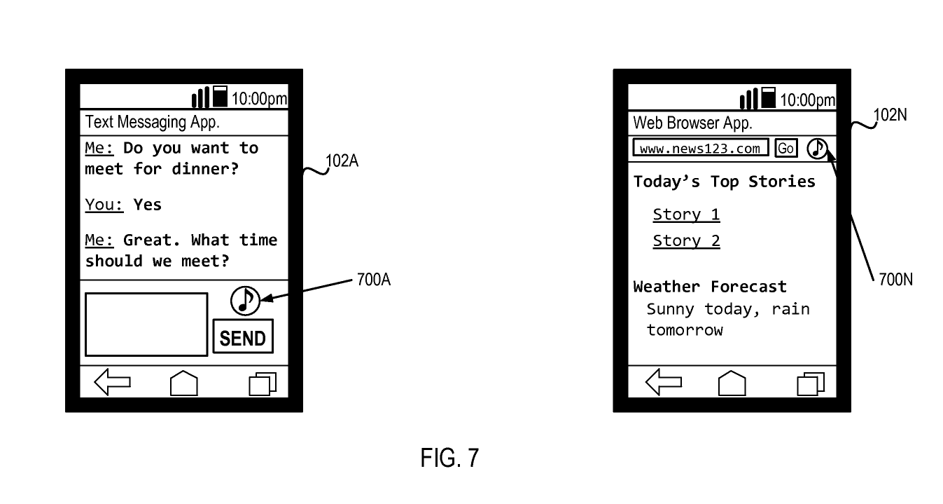

At block 610, a media content capture trigger can be presented. In certain implementations, such a media content capture trigger can be presented in relation to one or more applications, such as an application executing at a user device 102. For example, the referenced media content capture trigger can include an icon (or any other such indicator, e.g., a button, text hyperlink, etc.) that can be incorporated within and/or otherwise presented in conjunction with the interface of one or more other applications that are executing on a user device. By way of illustration, FIG. 7 depicts exemplary implementations of such a media content capture trigger. As shown in FIG. 7, user device 102A is a device such as a smartphone that is executing a text messaging application. It can be appreciated that a media content capture trigger 700A is incorporated within the interface of the text messaging application. As is also shown in FIG. 7, user device 102N is a device such as a smartphone that is executing a web browser application. It can be appreciated that a media content capture trigger 700N is incorporated within the interface of the web browser application. In doing so, a user can select or otherwise initiate such a trigger (e.g., by pressing on the icon via a touchscreen interface) while utilizing/interacting with the text messaging, web browser, etc., application (as opposed to exiting the text messaging application, for example, in order to initiate a separate mobile application, such as in the manner described at block 220 in relation to FIG. 2). In one aspect, block 610 is performed by media content capture engine 112.

At block 620, one or more media content segments can be captured. In certain implementations, such media content segments can be captured at and/or in relation to a user device. For example, the referenced media content segments (e.g., an audio clip of the perceived media content originating at the radio, television, etc.) can be captured at a user device via an integrated audio and/or video capture device (e.g., a microphone or camera). Moreover, in certain implementations, such media content segments can be captured based on a selection of a media content capture trigger (such as the media content capture trigger presented at block 610, as shown in FIG. 7). In one aspect, block 620 is performed by media content capture engine 112.

Moreover, in certain implementations user device 102 can be configured to continuously and/or periodically capture media content (i.e., even without user initiation of a media content capture trigger). Upon selecting or otherwise initiating a user interface element (e.g., a media content capture trigger), a listing or history of previously captured media content segments can be presented, and a user can select one or more of such media content segments to be provided to a remote device such as server machine 120 (e.g., even when the audio/video prompt desired by the user is no longer being played/displayed).

At block 630, one or more media content segments (such as those captured at block 620) can be provided to a remote device. For example, upon hearing, seeing, or otherwise perceiving media content (e.g., hearing ‘Jim's Pizza radio jingle’ playing on the radio, hearing/seeing a prompt on television to “Please vote now for your favorite ‘Talent Show’ star,” etc.), a user can initiate or select a media content capture trigger (e.g., an icon or other such indicator that is incorporated within and/or presented in conjunction with another application, as shown in FIG. 7, and/or a dedicated mobile application executing on the user device 102, such as is described at block 220 in relation to FIG. 2). As noted, the media content capture trigger can be configured to capture a media content segment (e.g., an audio clip of the perceived media content originating at the radio, television, etc.) and can further provide (e.g., upload) the media content segment to a remote device such as server machine 120 (e.g., via network 110). In one aspect, block 630 is performed by media content capture engine 112.

At block 640, one or more instructions can be received. In certain implementations, one or more of the referenced instructions can be associated with one or more media content segments (such as the media content segments captured at block 620 and/or provided at block 630). Moreover, in certain implementations one or more of the referenced instructions can correspond to one or more operations. For example, as described in relation to FIG. 2 (e.g., at blocks 230-250), a user device can receive various instructions, such as from server machine 120. As described with respect to FIG. 2, in certain implementations such instructions can be provided based on a selection of various corresponding operations, such as based on various characteristics associated with the user device (e.g., location, demographics, interests, etc.), while in other implementations comparable instructions can be provided even to user devices having different characteristics. Moreover, as described, in certain implementations several instructions can be provided to (and received by) a user device and a user can, for example, select from among the provided instructions at the user device. In one aspect, block 640 is performed by instruction presentation engine 122.

At block 650, one or more instructions (such as the instructions received at block 640) can be presented. In certain implementations, such instructions can be presented at and/or in relation to a user device. For example, having received one or more instructions (e.g., an instruction to call a particular phone number, navigate to a particular website, etc.), such instructions can be presented, for example, at the user device. In doing so, the user can review the received instructions and decide whether to take further action with respect to the instruction(s). In one aspect, block 650 is performed by instruction presentation engine 122.

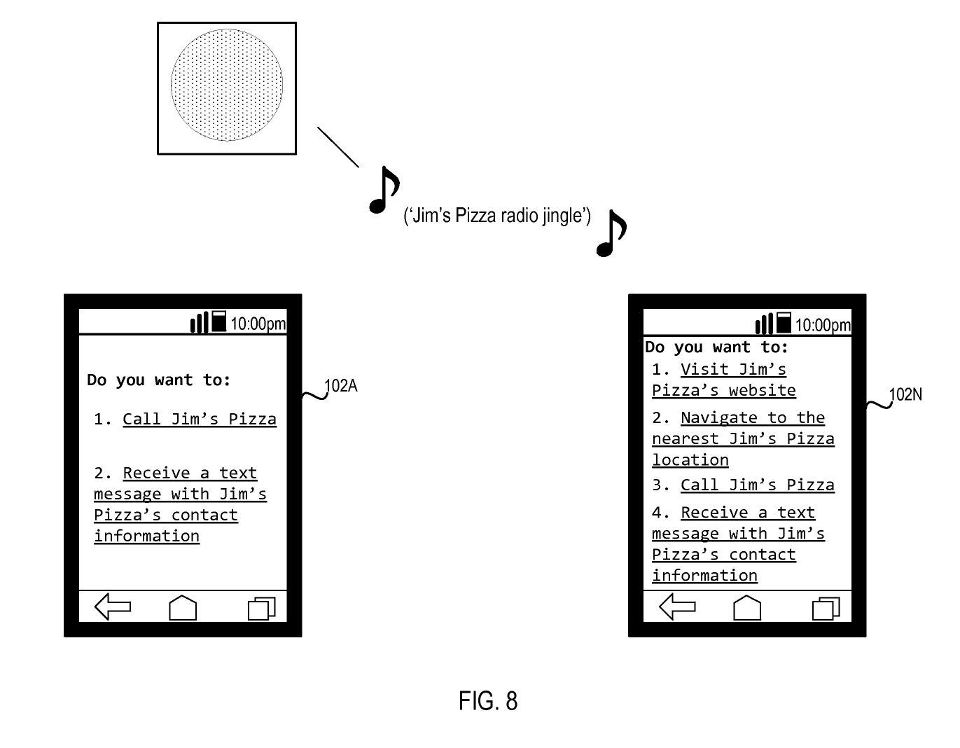

In certain implementations, one or more of the referenced instructions can be presented (such as at a user device) based on various operational characteristics of the user device. By way of illustration, such operational characteristics can include an operational capability of the user device. For example, FIG. 8 depicts an exemplary scenario whereby media content segments corresponding to Jim's Pizza radio jingle′ are captured by both user devices 102A and 102N (e.g., via a media content capture trigger and/or a dedicated application) and transmitted/provided to a remote device such as server machine 120. In response, various instructions can be provided by a remote device and received by the respective user devices. It should be noted that, in certain implementations, each user device can receive the same or a comparable set of instructions. For example and with reference to FIG. 8, both device 102A and device 102N can receive a set of instructions that includes the following instructions: ‘Call Jim's Pizza,’ Receive a text message with Jim's Pizza's contact information,′ Visit Jim's Pizza's website,′ and ‘Navigate to the nearest Jim's Pizza location.’ However, while device 102N may be a smartphone device having internet and navigation capabilities (in addition to cellular phone/text messaging capabilities), device 102A may be a cellular phone having substantially only cellular phone and text messaging capabilities. Accordingly, while user device 102N is capable of performing any number of the associated instructions, user device 102A is only capable of performing telephone call and text messaging-related instructions. Thus, while both user device 102A and user device 102N have captured substantially the same media content segment (i.e., ‘Jim's Pizza radio jingle’) and received substantially the same set of instructions, only those instructions corresponding to telephone call/text message functionality are presented at user device 102A, while user device 102N can present each of the received instructions (including visiting a website, navigating to a location, etc.), in light of the respective operational capabilities of each device.

By way of further example, the referenced operational characteristics (on the basis of which the referenced instructions can, for example, be presented) can include a current operation of a user device (e.g., an application that is presently executing at the device), a recent operation of a user device (e.g., an application that was recently executed at the device), and/or a frequent operation of the user device (e.g., an application that is often executed at the device). For example, in a scenario where a set of several instructions (e.g., to make a phone call, visit a web site, etc.) are provided to and/or received by a user device (such as in response to the capturing and/or providing of a media content segment, as described herein), one or more of such instructions can be presented (or be presented in a prioritized manner) based on the current, recent, and/or frequent operation of the user device. By way of illustration and with reference to FIG. 8, in relation to user device 102N (a smartphone having web browsing, navigation, phone, and text messaging capabilities), upon receiving a set of multiple instructions (e.g., ‘Call Jim's Pizza,’ Receive a text message with Jim's Pizza's contact information,′ Visit Jim's Pizza's website,′ and ‘Navigate to the nearest Jim's Pizza location’), the referenced instructions can be presented, for example, based on a recent operation of the user device (e.g., if the device was recently executing the web browser application, the ‘Visit Jim's Pizza's website’ can be prioritized in the presentation of instructions, as shown in FIG. 8), a current operation of the user device (e.g., if the device is currently executing a navigation application, the ‘Navigate to the nearest Jim's Pizza location’ instruction can be prioritized in the presentation of instructions, as shown in FIG. 8), etc. In doing so, in a scenario where multiple instructions may be available for presentation at a user device, those instructions that are relatively more likely to be of interest/relevance to the user (based on, for example, the manner in which the device is currently operating, recently operated, etc.) can be presented and/or prioritized for presentation.

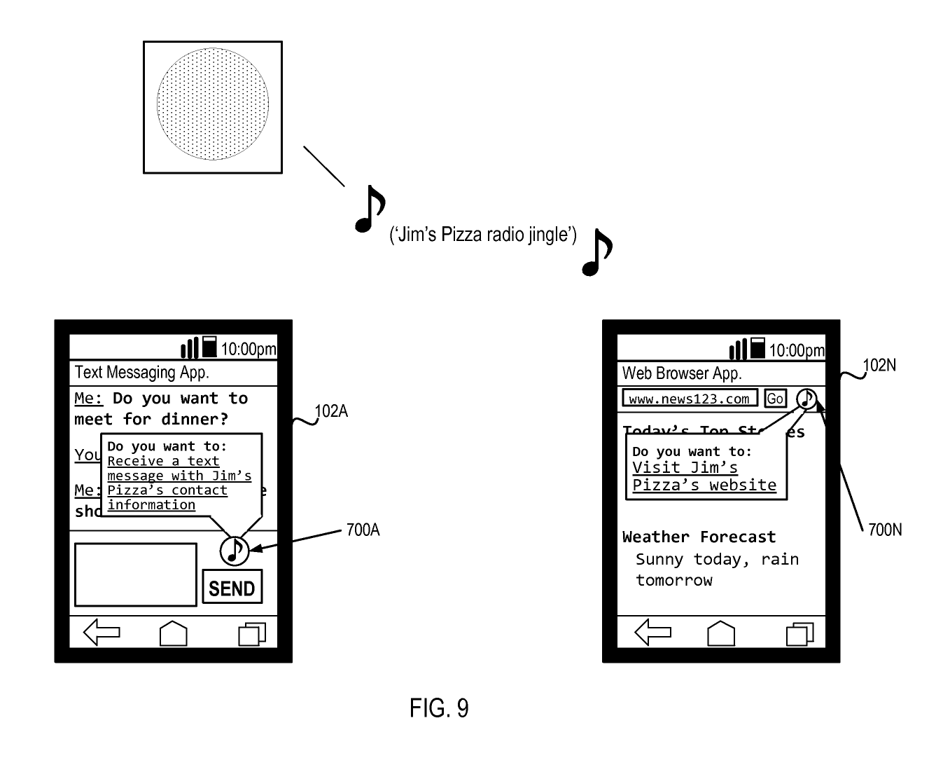

Additionally, in certain implementations, one or more of the referenced instructions can be presented (such as at a user device) in relation to one or more applications executing at a user device. For example, FIG. 9 depicts an exemplary scenario whereby media content segments corresponding to Jim's Pizza radio jingle′ are captured by both user devices 102A and 102N via a media content capture trigger (700A and 700N, respectively) that is incorporated within the interface of the respective text messaging and web browser applications (as described, for example, in relation to FIG. 7). As described herein, comparable media content segments (i.e., of ‘Jim's Pizza radio jingle’) can be captured and transmitted/provided to a remote device such as server machine 120, and, in response, various instructions can be provided by a remote device and received by the respective user devices. As also noted, in certain implementations, each user device can receive the same or a comparable set of instructions. Thus, for example and with reference to FIG. 9, both device 102A and device 102N can receive a set of instructions that includes the following instructions: ‘Call Jim's Pizza,’ Receive a text message with Jim's Pizza's contact information,′ Visit Jim's Pizza's website,′ and ‘Navigate to the nearest Jim's Pizza location.’ Being that device 102A has provided the media content segment based on a selection of a media content capture trigger 700A that is incorporated within and/or otherwise presented in conjunction with the interface of a text messaging application, an instruction from among the set of received instructions that pertains to and/or is otherwise related to such an application (e.g., ‘Receive a text message with Jim's Pizza's contact information’) can be selected and/or provided, as shown in FIG. 9. With respect to device 102N, being that the device has provided the media content segment based on a selection of a media content capture trigger 700N that is incorporated within and/or otherwise presented in conjunction with the interface of a web browser application, an instruction from among the set of received instructions that pertains to and/or is otherwise related to such an application (e.g., ‘Visit Jim's Pizza's website’) can be selected and/or provided, as shown in FIG. 9. Thus, while both user device 102A and user device 102N may have comparable capabilities and may have captured substantially the same media content segment (i.e., ‘Jim's Pizza radio jingle’) and also received substantially the same set of instructions, being that the media content items were captured based on a selection of a media content capture trigger incorporated within a text messaging application and a web browser application, respectively, those instructions that correspond/relate to such applications can be selected and provided at the respective user devices, in light of the respective applications in relation to which the media content capture triggers were selected.

Moreover, in certain implementations, one or more of the referenced instructions can be presented (such as at a user device) based on various characteristics of and/or associated with the user device. By way of illustration, such characteristics (e.g., user characteristics associated with a user account or profile that is logged into the device) can include one or more interests, demographic, locations, etc. For example, in a scenario such as that depicted in FIG. 8 (where media content segments are captured by both user devices 102A and 102N, transmitted/provided to a remote device, and instructions are received by the respective user devices, as described herein), while in certain implementations the same or a comparable set of instructions can be received by each device, different instructions can be presented at each respective device based on characteristic(s) of/associated with the particular device. By way of illustration, in a scenario such as that depicted in FIG. 8, user device 102A can be associated with a demographic of ages 55-65 while user device 102N can be associated with a demographic of ages 18-25. Accordingly, while both user device 102A and user device 102N may have comparable capabilities and may have captured substantially the same media content segment (i.e., ‘Jim's Pizza radio jingle’) and also received substantially the same set of instructions, different instructions can be presented and/or prioritized in relation to each device based on the characteristics of/associated with each device. Thus, a phone call instruction (‘Call Jim's Pizza’) can be presented and/or prioritized in relation to device 102A, which is associated with a demographic of ages 55-65, based on a preference of the content provider (e.g., the advertiser) and/or a determination that users having such characteristic(s) have a preference for and/or respond relatively more favorably to phone call-related instructions. With respect to device 102N, which is associated with a demographic of ages 18-25, a ‘visit website’ instruction (‘Visit Jim's Pizza's website’) can be presented and/or prioritized based on a preference of the content provider (e.g., the advertiser) and/or a determination that users having such characteristic(s) have a preference for and/or respond relatively more favorably to such instructions.

It should be noted that in situations in which the systems discussed herein collect personal information about users, or may make use of personal information, the users may be provided with an opportunity to control whether programs or features collect user information (e.g., information about a user's media viewing history, interests, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

At block 660, a selection of one or more instructions (such as the instructions received at block 640 and/or presented at block 650) can be received. In doing so, a user can, for example, tap (e.g., in the case of a touchscreen interface), click on, or otherwise provide an indication of a desire or interest in pursuing the provided instruction. In one aspect, block 660 is performed by instruction presentation engine 122.

At block 670, the execution of one or more instructions (such as the instructions received at block 640 and/or presented at block 650) can be initiated. In certain implementations, the execution of such instructions can be initiated based on a selection (such as the selection received at block 660). For example, upon receiving a selection of a particular instruction (e.g., to visit a website, navigate to a location, etc.), the execution of the corresponding instruction can be initiated, such as by initializing a related application (e.g., a web browser, navigation application, etc.), and/or by providing one or more parameters (e.g., the website address, the street address to be navigated to, etc.) that may be required to perform the instruction. In one aspect, block 670 is performed by instruction presentation engine 122.

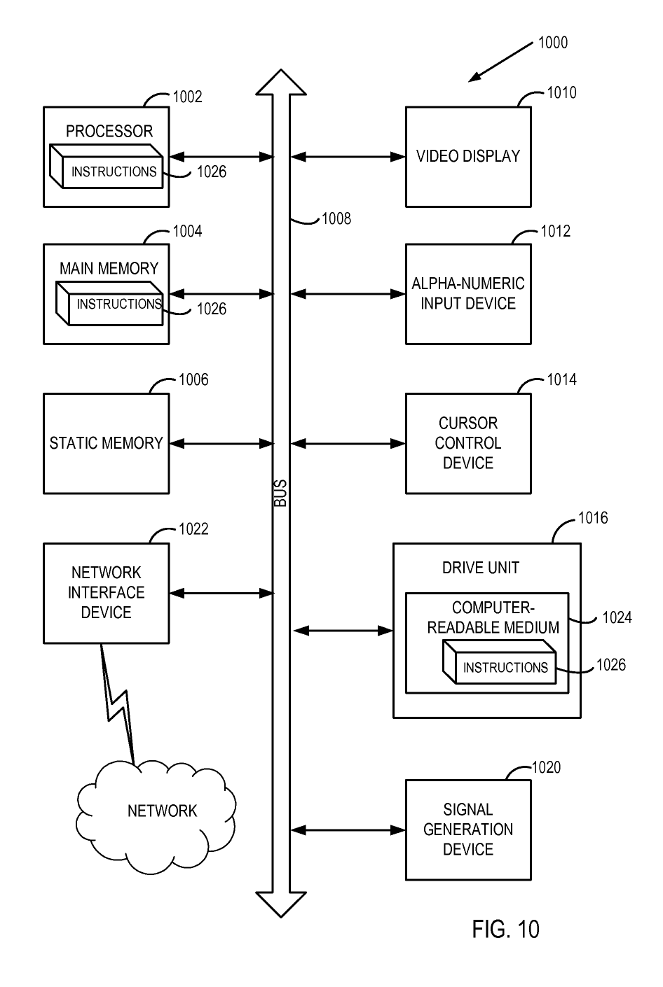

FIG. 10 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processing system (processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)), and a data storage device 1016, which communicate with each other via a bus 1008.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute instructions 1026 for performing the operations and steps discussed herein.

The computer system 1000 may further include a network interface device 1022. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1020 (e.g., a speaker).

The data storage device 1016 may include a computer-readable medium 1024 on which is stored one or more sets of instructions 1026 (e.g., instructions executed by collaboration manager 225, etc.) embodying any one or more of the methodologies or functions described herein. Instructions 1026 may also reside, completely or at least partially, within the main memory 1004 and/or within the processor 1002 during execution thereof by the computer system 1000, the main memory 1004 and the processor 1002 also constituting computer-readable media. Instructions 1026 may further be transmitted or received over a network via the network interface device 1022.

While the computer-readable storage medium 1024 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “selecting,” “providing,” “determining,” “identifying,” “associating,” “capturing,” “receiving,” “initiating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. A computer-implemented method comprising:
capturing, at a user device, one or more media content segments;
providing the one or more media content segments to a remote device;
receiving one or more instructions, each of the one or more instructions being associated with at least one of the one or more media content segments and corresponding to one or more operations; and
initiating, at the user device, execution of at least one of the one or more instructions.

2. The method of claim 1, further comprising presenting at least one of the one or more instructions at the user device.

3. The method of claim 2, wherein presenting at least one of the one or more instructions at the user device comprises presenting at least one of the one or more instructions at the user device based on one or more operational characteristics of the user device.

4. The method of claim 3, wherein the one or more operational characteristics of the user device comprise an operational capability of the user device.

5. The method of claim 3, wherein the one or more operational characteristics of the user device comprise at least one of (a) a current operation of the user device, (b) a recent operation of the user device, or (c) a frequent operation of the user device.

6. The method of claim 2, wherein presenting at least one of the one or more instructions at the user device comprises presenting at least one of the one or more instructions at the user device in relation to one or more applications executing at the user device.

7. The method of claim 1, further comprising presenting a media content capture trigger in relation to one or more applications executing at the user device.

8. The method of claim 7, wherein capturing, one or more media content segments comprises capturing one or more media content segments based on a selection of the media content capture trigger.

9. The method of claim 1, further comprising receiving a selection of at least one of the one or more instructions.

10. The method of claim 9, wherein initiating execution of at least one of the one or more instructions comprises initiating execution of at least one of the one or more instructions based on the selection.

11. A system comprising:
a memory; and
a processing device, coupled to the memory, to:
capture, at a user device, one or more media content segments;
provide the one or more media content segments to a remote device;
receive one or more instructions, each of the one or more instructions being associated with at least one of the one or more media content segments and corresponding to one or more operations; and
initiate execution of at least one of the one or more instructions.

12. The system of claim 11, wherein the processing device is further to present at least one of the one or more instructions at the user device.

13. The system of claim 12, wherein to present at least one of the one or more instructions at the user device is to present at least one of the one or more instructions at the user device based on one or more operational characteristics of the user device.

14. The system of claim 13, wherein the one or more operational characteristics of the user device comprise an operational capability of the user device.

15. The system of claim 13, wherein the one or more operational characteristics of the user device comprise at least one of (a) a current operation of the user device, (b) a recent operation of the user device, or (c) a frequent operation of the user device.

16. The system of claim 12, wherein to present at least one of the one or more instructions at the user device is to present at least one of the one or more instructions at the user device in relation to one or more applications that execute at the user device.

17. The system of claim 11, wherein the processing device is further to present a media content capture trigger in relation to one or more applications that execute at the user device.

18. The system of claim 17, wherein to capture one or more media content segments is to capture one or more media content segments based on a selection of the media content capture trigger.

19. The system of claim 1, wherein the processing device is further to receive a selection of at least one of the one or more instructions and wherein to initiate execution of at least one of the one or more instructions is to initiate execution of at least one of the one or more instructions based on the selection.

20. A computer readable medium having instructions stored thereon that, when executed by a processor, cause the processor to perform operations comprising:
capturing, at a user device, one or more media content segments;
providing the one or more media content segments to a remote device;
receiving one or more instructions, each of the one or more instructions being associated with at least one of the one or more media content segments and corresponding to one or more operations;
presenting at least one of the one or more instructions at the user device based on one or more characteristics of the user device; and
initiating execution of at least one of the one or more instructions.
